(19) United States
(12) Patent Application Publication
(10) Pub. No.: US 2024/0185253 A1
(43) Pub. Date: Jun. 6, 2024

(54) Time and Frequency Restricted Cryptocurrency Systems to Combat Climate Change

(71) Applicants: Jennifer Christa Sloan, Rincon, PR (US); James Ray Sloan, Rincon, PR (US)

(72) Inventors: Jennifer Christa Sloan, Rincon, PR (US); James Ray Sloan, Rincon, PR (US)

(21) Appl. No.: 18/061,448

(22) Filed: Dec. 3, 2022

(51) Int. Cl. G06Q 20/40; G06Q 20/06

(52) U.S. Cl. CPC G06Q 20/405; G06Q 20/065

(57) ABSTRACT

The invention is a system and method for time and frequency-restricted cryptocurrency transactions that use blockchain-based systems, tokens, coins, and exchanges to reduce energy consumption and increase energy efficiency. The system imposes time and frequency-specific restrictions on transactions to reduce temperature yield and lower the carbon footprint, which contributes to climate change. Transactions within the designated “open or free trade” period may incur zero or reduced fees, and any transactions outside of the transactors' designated time or frequency limits may result in higher fees, which a portion results in carbon credit offsets. The invention also includes an “ejection button” that allows transactors to buy or sell outside of their designated time or frequency limits without higher fees, with a percentage of the proceeds resulting in carbon credit offsets. The invention provides a more energy-efficient and environmentally-friendly alternative to existing cryptocurrency systems.

### FIELD OF INVENTION

The present invention relates to the field of cryptocurrency, virtual currency, and blockchain-based systems. More specifically, it relates to a method and/or exchanges that have transaction-time frame and/or transaction-frequency limitations to reduce energy consumption, increase energy efficiency and lower temperature yield, which contributes to climate change.

### BACKGROUND

Cryptocurrency transactions require a considerable amount of energy and result in a significant carbon footprint, which is harmful to the environment. The present invention aims to mitigate these effects by implementing time and frequency-specific transaction restrictions.

### SUMMARY OF THE INVENTION

The present invention provides a system for time- and frequency-restricted cryptocurrency transactions. Traders, holders, investors, and systems are only able to transact for a designated, certain number of hours per day or given period of time, for zero or low fees. Mining may not be restricted by time or frequency to process transactions. Transactions within the designated “open or free trade” hours or frequency of transactions or instances incur zero or low transaction fees, but any transactions outside of the transactors designated “open or free trade” hours or frequency of transactions or instances can result in higher transaction fees, which a portion or percentage may result in carbon credit offsets. The system can include an “ejection button” that a transactor can purchase access to, or be granted to use at any time, in order to buy or sell outside of their designated transaction time or frequency limits without higher fees. A percentage of the proceeds from purchased “ejection button” can result in carbon credit offsets.

### DETAILED DESCRIPTION OF THE INVENTION

The Time and Frequency-Restricted Cryptocurrency Transactions System is a web-based software system that utilizes blockchain technology to restrict the time and frequency of virtual currency transactions. The system is composed of various software components written in different forms of code, including but not limited to Solidity, C++, JavaScript, and Python.

The system's primary function is to reduce energy consumption and increase energy efficiency to lower temperature yield, which contributes to climate change.

The system operates by imposing time-specific and frequency-specific restrictions on virtual currency transactions. For instance, the system can limit traders, holders, investors, and systems to a designated, certain number of hours per day or given period of time for zero or low fees. Additionally, traders, holders, investors, and systems can be restricted to a designated, certain number of transactions per day or given period of time for zero or low fees.

Any transactions that occur within the designated “open or free trade” hours or frequency of transactions incur zero or low transaction fees. However, any transactions outside of the transactors' designated “open or free trade” hours or frequency of transactions can result in higher transaction fees. A portion or percentage of the higher transaction fees may result in carbon credit offsets.

Furthermore, the system can include an “ejection button” that a transactor can purchase or be granted to use at any time to buy or sell virtual currency outside of their designated transaction time or frequency limits without higher fees. A percentage of the proceeds from purchased “ejection buttons” results in carbon credit offsets.

1. A system for time and frequency-restricted cryptocurrency transactions, comprising a network of nodes that communicate with each other to validate and process transactions. The system imposes time and frequency-specific restrictions on transactions to reduce energy consumption, increase energy efficiency, and lower temperature yield, which contributes to climate change. Transactions within the designated “open or free trade” period incur zero or reduced fees, and any transactions outside of the transactors' designated time or frequency limits may result in higher fees, which a portion results in carbon credit offsets.

2. A method for allowing transactors to purchase or be granted an “ejection button” that allows them to buy or sell outside of their designated transaction time or frequency limits without higher fees. A percentage of the proceeds from purchased “ejection button” may result in carbon credit offsets. The system records the use of the “ejection button” in the blockchain ledger, and it is publicly visible to all nodes in the network.

3. A user interface that allows traders, holders, investors, and systems to set their designated transaction time or frequency limits, purchase or be granted the “ejection button,” and view their transaction history. The user interface also displays the designated “open or free trade” period and the current transaction fees. The system provides a more energy-efficient and environmentally-friendly alternative to existing cryptocurrency systems by reducing energy consumption and lowering the carbon footprint.
